(19) United States
(12) Patent Application Publication
(10) Pub. No.: US 2018/0189669 A1
(43) Pub. Date: Jul. 5, 2018

(54) IDENTIFICATION OF EVENT SCHEDULES

(71) Applicant: Uber Technologies, Inc., San Francisco, CA (US)

(72) Inventor: Sangick Jeon, San Francisco, CA (US)

(21) Appl. No.: 15/394,527

(22) Filed: Dec. 29, 2016

(51) Int. Cl. G06N 7/00; G06N 99/00

(52) U.S. Cl. CPC G06N 7/005; G06N 99/005

(57) ABSTRACT

A system predicts event type and event intensity within specified regions. The system trains a computer model to predict event intensity score values indicative of human activity within a certain geofence and occurring within a certain timeframe. The predicted event intensity score values are based on event data received from third party systems and analyzed by the system. The predicted event intensity score values may be further based on trip data related to trips facilitated by the system. With the predicted activity, the system can modify trips and provide adequate resources for predicted events.

### BACKGROUND

### Field of Art

This disclosure relates generally to detection of event occurrence using one or more computer systems and more particularly to predicting city-specific event schedules using machine learning.

### Description of Art

Computerized systems provide a means of travel by connecting users requesting rides (e.g., “riders”) with users available to transport them (e.g., “providers”). When a rider submits a request for a ride to the system, the system may select a provider to service the request and transport the rider to a destination of the trip.

To provide prompt and reliable service to riders, it would be helpful for the systems to be able to anticipate the population density and flow of people throughout a region. Unexpected increases or decreases in the number of people in a region can lead to safety incidents. For example, a city hosting an event may experience additional traffic accidents due to an influx of travelers who are unfamiliar with the roads. A city's data for events may be difficult to obtain, making travel prediction challenging.

### SUMMARY

A system predicts regional event schedules and uses the predicted information to predict population densities and flows of people within regions. The predictions are used to trigger a variety of precautionary interventions in the affected areas. To predict events and population flows, the system receives data for various events and population flows to predict future population flows based on event data. The system receives data associated with events from third party systems such as media and sports league websites. The event data may include information about a date and time of an event, a location of an event, a type of the event, or expected number of attendees. Event data can be received in forms that are structured, as in responses to application programming interface (API) calls provided by an event webpage of the provider. Event data can also be received in unstructured forms, such as by scraping websites for information about upcoming events. Data associated with trips facilitated by the system is also collected.

The system uses the event data and data about past trips to train one or more computer models to predict values for one or more event intensity scores that represent a predicted population density or a predicted directionality of human movement throughout a region. Examples of event data that may be used to train the system models may include counts of a number of performances scheduled at a theater, a count of a number of national or regional holidays that are expected to be celebrated within a region, a count of a number of sports events occurring at a local stadium within a week, and predicted events based on social media posts. Examples of training data that may be used as event intensity score values for training the model include a number of pickups and drop-offs facilitated by the system within a region, and the number of calls made from a region within a specified timeframe.

The system receives new event data from third party systems and uses it to generate predictions about the population density of a region with respect to predicted events. To predict population density and population movement, the system compares data associated with incoming event data with featurized representations of past data received about events at similar times within the region. In an embodiment, the prediction of event-related population density and population movement is represented by one or more event intensity score values.

Responsive to event activity predictions, the system may alter parameters associated with coordinating individual trips or the system may alter parameters associated with facilitating trips within or near the region more generally. Different trip parameters may be altered in different situations, such as depending on the values predicted for associated event intensity scores. For example, if a high number of trip pickups is predicted to occur within a region, the system may deploy or incentivize an increased number of providers to the region at the predicted time.

The features and advantages described in this summary and the following detailed description are not limiting and not all-inclusive. Many additional features and advantages will be apparent to one of ordinary skill in the art in view of the drawings, specification, and claims hereof.

### BRIEF DESCRIPTION OF THE DRAWINGS

FIG. 1 is a high-level block diagram of a system environment for a system, in accordance with an embodiment.

FIG. 2 is a high-level block diagram of a system architecture for a system, in accordance with an embodiment.

FIG. 3 illustrates an example of training data for an event model representing a specific geofence, in accordance with an embodiment.

FIG. 4 is a high-level block diagram that illustrates a process of training an event model, in accordance with an embodiment.

FIG. 5 is an example map depicting geofences that correspond to predicted events, in accordance with an embodiment.

FIG. 6 is a flowchart illustrating a method of predicting events and event intensities within a geofence, in accordance with an embodiment.

FIG. 7 is a block diagram illustrating components of an example machine for reading and executing instructions from a machine-readable medium.

The figures depict an embodiment of the invention for purposes of illustration only. One skilled in the art will readily recognize from the following description that alternative embodiments of the structures and methods illustrated herein may be employed without departing from the principles of the invention described herein.

### DETAILED DESCRIPTION

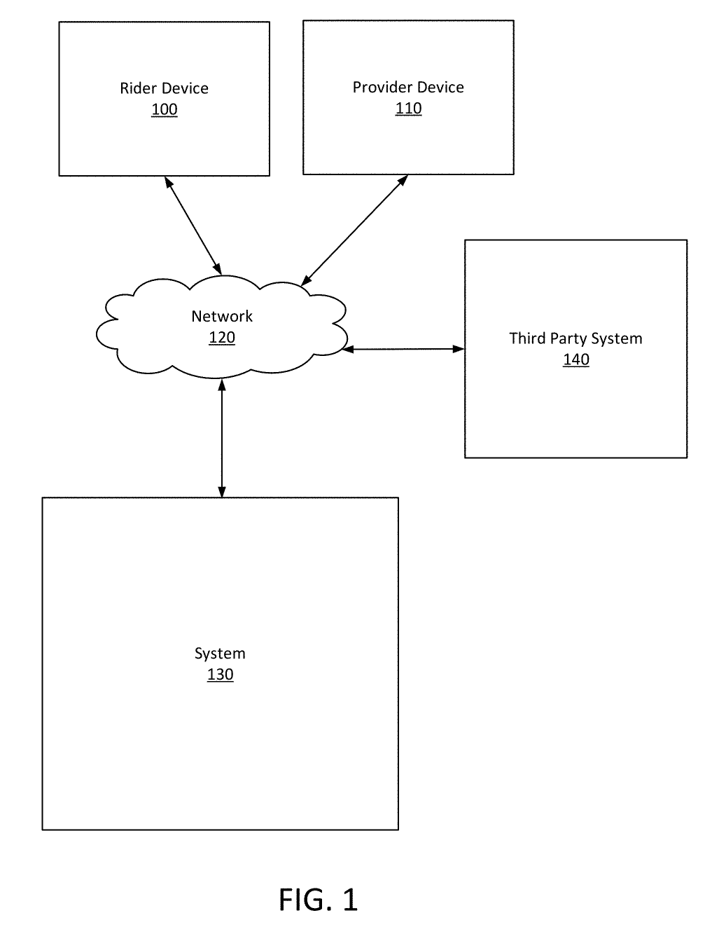

FIG. 1 is a high-level block diagram of a system environment for a system 130, in accordance with some embodiments. The system 130 can facilitate coordination of a number of services between a rider device and a provider device. Example embodiments below are described in the context of requesting, coordinating, and providing rides for travel or transport. However, it will be appreciated that the system 130 can facilitate any suitable number of services in alternative embodiments. For instance, examples of services can include transportation of items (such as food, products, freight cargo, medical items, animals, etc.) and/or services (medical care, entertainment, labor, etc.).

In the illustrative example shown in FIG. 1, the system 130 includes a rider device 100, a provider device 110, a third party system 140, a network 120, and the system 130. For clarity, although only one rider device 100 and one provider device 110 are shown in FIG. 1, alternate embodiments of the system environment can have any number of rider devices 100, provider devices 110, and third party systems 140. The functions performed by the various entities of FIG. 1 may vary in different embodiments. The system 130 receives and analyzes data related to regional events from the rider devices 100, the provider devices 110, and one or more third party systems 140. When a future event is predicted, the system 130 initiates appropriate precautionary modifications to trips it coordinates in the region of the predicted event at the predicted time. The system 130 may additionally detect past or ongoing events and initiate reactionary modifications to trips it is coordinating nearby to the past or ongoing event.

A rider requests transportation (via a “trip request”) from the system 130 through a rider device 100. A provider receives requests to provide transportation from the system 130 through a provider device 110. Rider devices 100 and provider devices 110 can be personal or mobile computing devices, such as smartphones, tablets, or notebook computers. In some embodiments, the rider device 100 and provider device 110 execute a client application that uses an application programming interface (API) to communicate with the system 130 through the network 120.

Through operation of the rider device 100, a rider can provide a trip request to the system 130. For example, a trip request may include one or more of user identification information, the number of passengers for the trip, a requested type of the provider (e.g., a vehicle type or service option identifier), the pickup location (e.g., a user-specified location, or a current location of the rider device 100), and/or the destination for the trip. The current location of the rider device 100 may be designated by the rider, or detected using a location sensor of the rider device 100 (e.g., a global positioning system (GPS) receiver).

A provider can use the provider device 110 to interact with the system 130 and receive invitations to provide transportation for riders. In some embodiments, the provider is a person operating a vehicle capable of transporting passengers. In some embodiments, the provider is an autonomous vehicle that receives routing instructions from the system 130. For convenience, this disclosure generally uses a car with a driver as an example provider. However, the embodiments described herein may be adapted for a provider operating alternative vehicles or for autonomous vehicles.

A provider can receive assignment requests through the provider device 110. An assignment request identifies a rider who submitted a trip request to the system 130 and identifies the pickup location of the rider for a trip. For example, the system 130 can receive a trip request from a rider device 100, select a provider from a pool of available (or “open”) or soon-to-be available users to provide the trip, and transmit an assignment request to the selected provider's provider device 110. In some embodiments, a provider can indicate availability, via a client application on the provider device 110, for receiving assignment requests. This availability may also be referred to herein as being “online” (available to receive assignment requests) or “offline” (unavailable to receive assignment requests). For example, a provider can decide to start receiving assignment requests by going online (e.g., by launching a client application or providing input on the client application to indicate that the provider wants to receive invitations), and stop receiving assignment requests by going offline. In some embodiments, when a provider device 110 receives an assignment request, the provider has the option of accepting or rejecting the assignment request. By accepting the assignment request, the provider is assigned to the rider, and is provided the rider's trip details, such as pickup location and trip destination location. In one example, the rider's trip details are provided to the provider device 110 as part of the invitation or assignment request.

In some embodiments, the system 130 provides routing instructions to a provider through the provider device 110 when the provider accepts an assignment request. The routing instructions can direct a provider from their current location to the location of the rider or can direct a provider to the rider's destination. The provider device 110 can present the routing instructions to the provider in step-by-step instructions or can present the entire route at once.

Rider devices 100 and provider devices 110 may interact with the system 130 through client applications configured to interact with the system 130. The client applications of the rider devices 100 and provider devices 110 can present information received from the system 130 on a user interface, such as a map of the geographic region, the current location of the rider device 100 or provider device 110, and routing and navigation information. The client application running on the rider device 100 or provider device 110 can determine the current location and provide the current location to the system 130.

The rider devices 100 and provider devices 110 can communicate with the system 130 via the network 120, which may comprise any combination of local area and wide area networks employing wired or wireless communication links. In some embodiments, all or some of the communication on the network 120 may be encrypted.

Third party systems 140 are computer systems that may communicate with the system via the network 120. The third party system 140 may include information relating to upcoming events that may impact the travel coordinated by the system 130. Depending on the particular third party system 140 and type of information stored therein, the data may have varying reliability for predicting impacts on travel. Third party systems 140 include online systems hosting websites, such as news websites, sports league websites, weather forecasting websites, social networking systems, encyclopedia websites, and ticket selling systems. Third party systems 140 may additionally include online systems that provide an API from which developers may access data that is provided by the third party system 140. Information collected from the third party systems 140 includes event data that is used to indicate a likelihood that events will occur within one or more timeframes. Data indicating future events is collected as well as records of past events. Events types may include celebrations, emergencies, weather conditions, and the like. Some data obtained from the third party system 140 may be predictive. For example, a football league might post schedules for future games on its website, which may be predictive of when a game will occur. Data obtained from third party systems 140 may also be reactive to an event. For example, a news organization posts information about emergencies after they happen.

As described above, the system 130 matches riders requesting transportation with providers that can transport the riders from their pick up location to their destination. The system 130 can store maps of geographic regions in which the system 130 services riders and providers, and may provide information about these maps to riders and providers through the rider devices 100 and provider devices 110. For example, the system 130 may provide routing directions to the provider to pick up the rider and transport the rider to a destination. The system 130 may additionally store virtual delineations of regions (e.g., geofences) in relation to the maps of geographic regions. Predicted events and population densities are associated with geofences representing the geographic region in which the events have occurred or in which the events are predicted to occur.

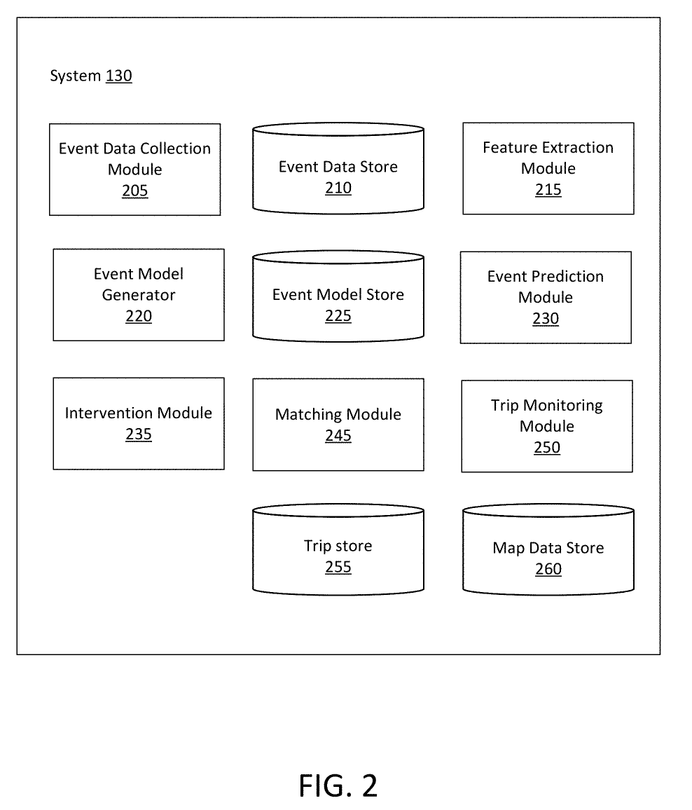

FIG. 2 is a high-level block diagram of a system architecture for the system 130, in accordance with some embodiments. The system includes various module and data stores to process event data, predict events, match providers, and monitor trips. The system 130 comprises an event data collection module 205, an event data store 210, a feature extraction module 215, an event model generator 220, an event model store 225, an event prediction module 230, an intervention module 235, a matching module 245, a trip monitoring module 250, a trip store 255, and a map data store 260. Computer components such as web servers, network interfaces, security functions, load balancers, failover servers, management and network operations consoles, and the like are not shown so as to not obscure the details of the system architecture. Additionally, the system 130 may contain more, fewer, or different components than those shown in FIG. 2 and the functionality of the components as described herein may be distributed differently from the description herein. Furthermore, the components of FIG. 2 can be included, additionally or alternatively, in any suitable component shown in FIG. 1.

The map data store 260 stores maps of geographic regions in which the system 130 offers trip coordination services. The maps contain information about roads within the geographic regions. For the purposes of this disclosure, roads can include any route between two places that allows travel by foot, motor vehicle, bicycle or other form of travel. Examples of roads include streets, highways, freeways, trails, bridges, tunnels, toll roads, waterways, airways, or crossings. Roads may be restricted to certain users, or may be available for public use. Roads can connect to other roads at intersections. An intersection is a section of one or more roads that allows a user to travel from one road to another. Roads are divided into road segments, where road segments are portions of roads that are uninterrupted by intersections with other roads. For example, a road segment would extend between two adjacent intersections on a surface street or between two adjacent entrances/exits on a highway.

A map of a geographic region may be represented using a graph of the road segments. In some embodiments, the nodes of a graph of a map are road segments and edges between road segments represent intersections of road segments. In some embodiments, nodes of the graph represent intersections between road segments and edges represent the road segments themselves. The map data store 260 also stores properties of the map, which may be stored in association with nodes or edges of a graph representing the map. Map properties can include road properties that describe characteristics of the road segments, such as speed limits, road directionality (e.g., one-way, two-way), traffic history, traffic conditions, addresses on the road segment, length of the road segment, and type of the road segment (e.g., surface street, residential, highway, toll). The map properties also can include properties about intersections, such as turn restrictions, light timing information, throughput, and connecting road segments. In some embodiments, the map properties also include properties describing the geographic region as a whole or portions of the geographic region, such as weather within the geographic region, geopolitical boundaries (e.g., city limits, county borders, state borders, country borders), and topological properties.

The map data store 260 additionally stores information about geofences. A geofence is a virtual perimeter geographically enclosing a portion of map data. Geofences are used to delineate specific geographic regions and may be applied for various reasons, such as categorization or alerts. In one embodiment, a large region is subdivided into many smaller regions using geofences, and data about events is collected with respect to effects within individual geofences. Geofences may be established along political boundaries (e.g., city borders), census tracts, neighborhood outlines, using arbitrary grid cells (e.g., an overlay of hexagons on a map), and/or a group of grid cells selected based on one or more characteristics of the region corresponding to the cells.

The event data collection module 205 receives or accesses data from third party systems 140 via the network 120. Event data can include data that associates an event with one or more geofences that include regions affected by an event. In alternative embodiments, the event data collection module 205 associates the event to one or more geofences, e.g., based on matching location information and, in example embodiments, size information of the event data to the one or more geofences.

The event data collection module 205 collects two broad kinds of data from third party systems: structured and unstructured event data. Event data is “structured” if it is received in a known format in response to a known request. In other words, structured event data may be received from a third party system 140 in response to a request, sent by the event data collection module 205 to an API of the third party system 140. For example, a ticket selling organization may provide an API that the event data collection module 205 can call to return information about a number of theatrical performances that are showing at a theater on a given day. Event data is “unstructured” if the information source does not have a predetermined format known by the event data collection module 205. In the case of unstructured event data, the event data collection module 205 determines the meaning of the received data by processing the information. For example, event data may be collected by scraping a web page or by retrieving available user comments or remarks from the third party system 140. For example, data about events may be obtained using natural language processing techniques to select and analyze user posts about events published to social media systems.

The event data store 210 stores event data collected by the event data collection module 205. In one embodiment, the event data store 210 holds the raw data scraped from the websites and the responses to API calls made to third party systems.

The feature extraction module 215 extracts information about events from data stored in the event data store 225 and information stored in the trip store 255. Some examples of characteristics that may be extracted by the feature extraction module include location, start time, end time (e.g., specified by data or determined by a presence of some duration value such as “7 pm” or “3 hrs”), venue, and/or event capacity. The extracted features may be used to determine characteristics of a predicted event, and to determine a likelihood that an identified event is going to occur and affect trips coordinated by the system 130.

The information is extracted in the form of features (e.g., variables representing specific event categories that may be assigned a score). The feature extraction module 215 may analyze different data inputs in different ways to extract a score. Structured data may already be in a form that can be used, such as when an API call returns a count of the number of events occurring within a geofence. In some embodiments, the feature extraction module uses predetermined functions for converting data received in response to API calls to another form of data, for example turning a list of the names of shows at a theater into a count of the number of shows that are playing.

The feature extraction module 215 also analyzes and extracts feature values from unstructured data. In some embodiments, the feature extraction module 215 analyzes unstructured data using text analysis and natural language processing techniques (e.g., hierarchical clustering, knowledge-driven approaches based on lexico-syntactic and lexico-semantic patterns, and/or TABARI for event coding using custom actor and location libraries) to detect certain words or phrases, for example, phrases indicative of an event or date. The feature extraction module 215 may additionally be configured to store data about events that have already happened, as stored in the trip store 255.

The event prediction module 230 predicts future events and/or event intensity values for detected future events using the event models stored in the event model store 225. As discussed below, these models may be trained using the feature values relating to events and trip activity, and used to predict event activity and impact on the trips of the system 130 because of the event data. Event intensity values may be indicative of whether an event is occurring within a certain geofence and within a specified time frame.

The event prediction module 230 may also, or as an alternative, predict whether possible events are actually likely to occur and affect coordinated trips. To do so, the event prediction module 230 initially identifies a set of candidate events that may occur within a certain geofence and within a specified time frame. For example, a set of candidate events may be selected based on features extracted by the feature extraction module 215, such as event location and/or event start time. As examples, these candidate events may correspond to dates and times described in unstructured data. The event prediction module 230 may validate events from the set of candidate events to determine which of these candidate events is predicted to occur. The validated event may also designate or confirm (if present in the initial candidate data) characteristics of the event, such as a type of the event. That is, the event prediction module 230 can determine a likelihood that an event with a predicted event type will occur. The event prediction module 230 may use machine learned models, individual classifiers, and/or multi-class classifiers to validate a predicted event type for an event, based on data about the event extracted by the feature extraction module 215. For example, when each type of event has a model that predicts the likelihood of that type of event, an identified candidate event may be classified by the event prediction module 230 as having a 30% chance of being an emergency event, a 50% chance of being a weather-related event, and an 87% chance of being a celebration event. In another example, an initial classifier may predict the likelihood of any event occurring, and a multi-class classifier may predict the likelihood of the likely event having a given event type, such as 30% likelihood of an emergency event, 50% likelihood of a weather-related event, and 20% likelihood of a celebration event. In some embodiments, a candidate event may be classified as being a “non-event,” for example, a model or classifier may determine that a candidate event does not exceed a threshold likelihood of being any known type of event based on its extracted features. In one embodiment, an event may be verified by monitoring an area around a location of a predicted event at or near the time of the predicted event and applying models or classifiers to data from the monitored area to determine if an event is occurring as predicted. In one embodiment, an event may be verified by surveying riders and providers about nearby events and/or their reasons for traveling.

In one embodiment, event intensity scores are determined for validated events (e.g., events that receive above a threshold likelihood value for being a type of event). Event intensity scores may be based on various metrics that may represent a number of people in an area. Some examples of event intensity scores include a count of a number of riders that are dropped off within a geofence, a count of a number of riders that are picked up in the geofence, a running total of the number of riders dropped off within the geofence less the number of riders picked up within the geofence area over a period of time (e.g., a period of time that covers at least the event), a value representative of the number or intensity of lights in a geofence as detected by a satellite at night, a number of cars within a geofence as detected by satellite imagery or user-provided position data (e.g., GPS data), the spatial movement of cars within a geofence, and counts of phone calls made from within the geofence. In some embodiments, an overall event intensity score is calculated with a predetermined function that combines one or more event intensity scores.

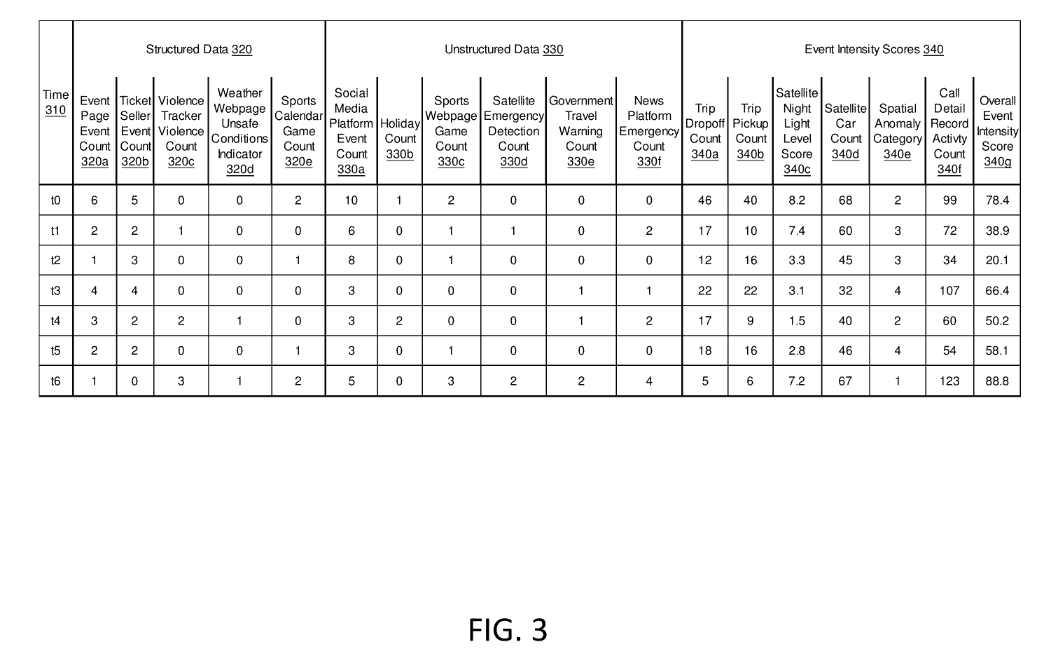

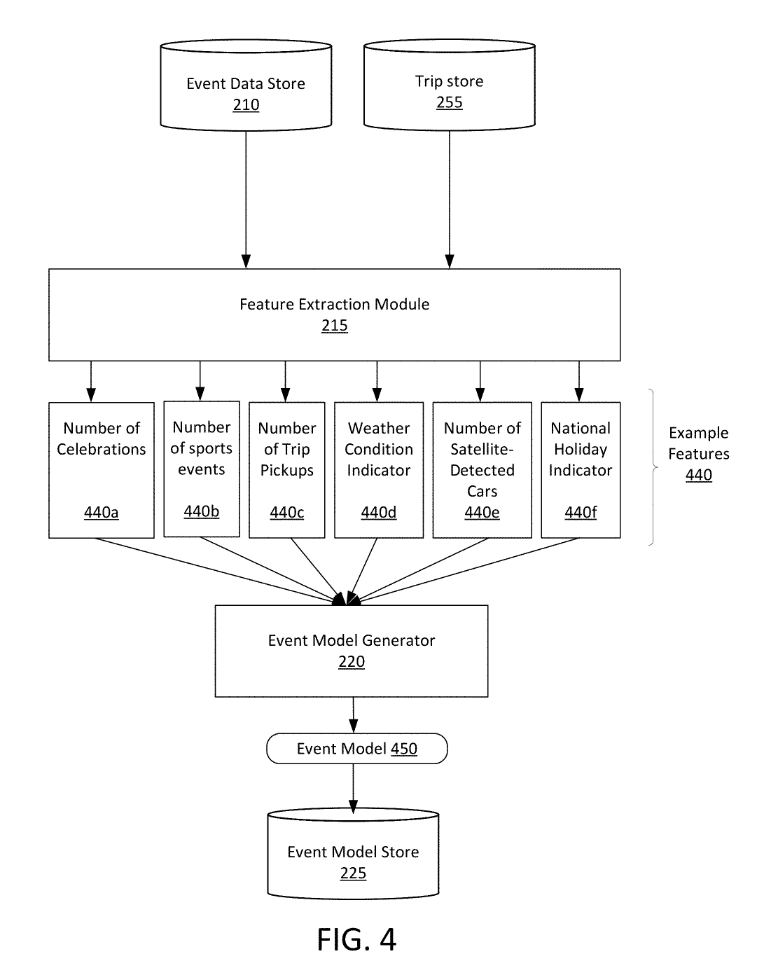

The event prediction module 230 determines values for event intensity scores by leveraging supervised machine learning models. The event prediction model is trained to predict event intensity score values using both historical and real-time event features in conjunction with previously observed event intensity scores. The prior event data may be stored as extracted event features in the event data store 210. In some embodiments the event prediction module 230 is trained to predict values for specific event intensity scores rather than for a more general overall event intensity score. For example, the event prediction module can predict whether trip drop-offs or trip pick-ups in a geofence will be converging, diverging, steady, or stopped within a geofence for a certain time frame. The event prediction module 230 outputs predicted values for one or more event intensity scores to estimate the dynamic population density of the geofenced region within the timeframe represented by the event prediction model. The event intensity scores may be associated with validated events in the geofence to describe event intensity of the validated events. The features used for an event prediction model and training thereof are further discussed below with respect to the event model generator 220 and FIGS. 3-4.

The intervention module 235 selects interventions (e.g., modifications) for the system 130 to implement in response to event predictions. Interventions may be reactive or proactive. Reactive interventions are implemented in response to detected events that have already happened or that are ongoing. Some examples of reactive interventions include directing drivers to safe pickup locations where they can aid in evacuation efforts in the case of emergencies, sending safety messages to riders and providers in an affected area, sending messages to riders informing them of predicted delays in regular traffic patterns, and routing trips away from roads that may be more dangerous in extreme weather conditions. In some embodiments, the intervention module 235 receives information about past or ongoing events from the event prediction module 230 when the event prediction module analyzes a model that is representative of a present or past timeframe from the event model store 225.

Proactive interventions are implemented by the intervention module 235 in anticipation of events that are predicted to occur. The intervention module 235 receives predicted event intensity scores for geofences within certain timeframes from the event prediction module 230. In some embodiments, the intervention module 235 additionally receives information about the types and identities of events that are expected to cause the predicted event intensity score values. Some examples of proactive interventions include sending safety tips to providers within the geofence about how to navigate crowds, providing event data to public utilities to optimize traffic lights, optimizing pickup and drop-off locations and times, providing riders and/or providers with surveys to confirm that a scheduled pickup or drop-off occurred if navigation instructions were not followed, and routing additional providers to regions where trip pickups are expected to be in high demand and/or indicating to providers that a particular area has a high demand for providers.

The type of intervention selected for a validated event may depend on the type of event and the intensity of the event. Thus, a weather-related event of a low intensity may generate different interventions than a social or concert-related event of high intensity. For example, a low intensity weather event may generate only a message to remind drivers to be careful, while the high-intensity social event may be used to coordinate travel of users to or from the event. In addition, identified high-intensity events may also affect possible (e.g., candidate) pickup or drop off locations.

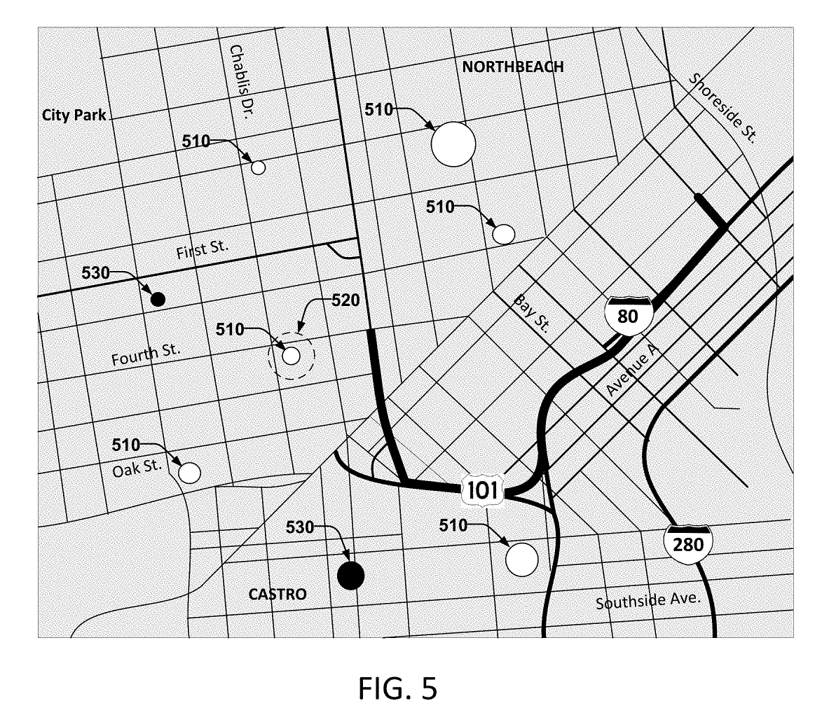

Interventions may be implemented at various scales. Some interventions involve sending messages about safety tips and traffic warnings to riders and providers in response to analyzed event data. Interventions can affect the system 130 in other ways as well. For example, the interventions can prompt the system 130 to collaborate with public safety organizations within the geofence (e.g., by transmitting data about predicted events) in order to provide services such as increased availability of public transit options. Additional example interventions are described with respect to FIG. 5 below.

The matching module 245 selects providers to service the trip requests of riders. The matching module 245 receives a trip request from a rider and determines a set of candidate providers that are online, open (e.g., are available to transport a rider), and near the requested pickup location for the rider. The matching module 245 selects a provider from the set of candidate providers and transmits an assignment request to the selected provider. The provider can be selected based on the provider's location, the rider's pickup location, the type of the provider, the amount of time the provider has been waiting for an assignment request and/or the destination of the trip, among other factors. In some embodiments, the matching module 245 selects the provider who is closest to the pickup location or who will take the least amount of time to travel to the pickup location (e.g., having the shortest estimated travel time to the pickup location). The matching module 245 sends an assignment request to the selected provider. If the provider accepts the assignment request, the matching module 245 assigns the provider to the rider. If the provider rejects the assignment request, the matching module 245 selects a new provider and sends an assignment request to the provider device 110 for that provider.

The matching module 245 additionally identifies appropriate changes that can be made to the parameters of the trip based on interventions selected by the intervention module 235 and matches (e.g., assigns) a provider to a rider accordingly. Some examples of alterations to the trip parameters include alerting the provider about nearby events via an application notification (e.g., in-app or out-of-app notification), text message, or other notification sent to the provider device 110, transmitting alternate routing directions to the pickup location based on detected traffic anomalies, and selecting optimal pickup locations and times. Additional examples of how trip parameters might change based on event monitoring and event predictions are included in a description of FIG. 5 below.

The trip monitoring module 250 receives data about trips as trips occur. Trip data may include information about a pickup location and a drop off location, telematics data collected from the vehicle of the provider, safety incident reports about accidents or interpersonal conflicts that occurred during the trip, and feedback such as ratings and incident reports submitted by riders and providers. In some embodiments, trip data can additionally include rider responses to survey questions about the quality of transportation provided by system 130 in relation to an event.

Trip data collected by the trip monitoring module 250 is stored in the trip store 255. The trip store 255 holds data about completed trips. The stored trip data can include a request that initiated the trip and associated metadata, data collected from the rider device 100 and the provider device 110 over the duration of the trip, and ratings and incident reports submitted by riders and providers regarding the trip experience. In one embodiment, the trip store can store data about whether a predicted event occurred (e.g., in response to user survey questions about the event) and the perceived intensity of events (e.g., how crowded areas seemed).

The event model generator 220 generates event models. The models predict event type and/or event intensity (e.g., population density) related to anticipated events (e.g., a model might predict the number of people within a geofence at a future time). In one embodiment, the event models are machine learned models.

An embodiment of the event model generator 220 generates the event models using supervised machine learning. The event model generator 220 trains and validates the models using training data derived from the event data stored in the event data store 210 and the trip data stored in the trip store 255. The event model generator 220 uses event data and trip features from past trips, and further uses confirmed values of event intensity scores as validation data for training the models to confirm that events expected by the event data resulted in some change in activity. In one embodiment, the event models are regenerated using updated training data on a periodic basis, such as every week or every 30 days. In some embodiments, one or more of the event models are regenerated or tuned whenever updated event data is received.

The event model store 225 stores the generated event models. In some embodiments, the event model store 225 stores multiple models for each geofence. For example, models may be generated for a variety of temporal units (e.g., day level models, hour level models, and minute level models). Within each temporal unit of analysis, a separate model may be built and maintained for different forecasting windows (e.g., one hour ahead, 3 hours ahead, 6 hours ahead, etc.).

FIG. 3 illustrates an example of training data for an event model representing a specific geofence, in accordance with an embodiment. The event model training data shown in FIG. 3 is for an event model for predicting event intensity, and includes time identifiers for data entries, values for features associated with structured data about events, values for features associated with unstructured data about events, and event intensity scores. Alternate embodiments of FIG. 3 may include more, fewer, or different features.

In the example of FIG. 3, the training data is represented as a table of event features. The table represents features for a specific timeframe within a specific geofence. A row in the table includes values assigned for features of the geofence at individual time units. The time 310 indicates a temporal unit at which values for the other event features in the set of training data are observed. The timeframe embodied by the model is represented using observations for discrete time units. The time units t0 through t6, as shown in FIG. 3 may be minutes, days, hours, or another time unit. For example, if the model in FIG. 3 represents events occurring over a week within a geofence, the values in the row demarcated by t0 can represent predicted and observed values for the first day of the week, the values in the t1 row represent the second day, and so on.

Event model training data includes several types of event features. Event features may be based on structured data 320 and unstructured data 330. Structured data 320 includes feature values obtained in a substantially direct and/or predetermined way, such as from an API call that returns a number of events occurring within a specified timeframe. Examples of structured data 320 shown in FIG. 3 include event page event count 320a, ticket seller event count 320b, violence tracker violence count 320c, weather webpage unsafe conditions indicator 320d, and sports calendar game count 320e. By contrast, unstructured data 330 is data that receives a value based on an analysis by the event model generator 220. Examples of event features derived from unstructured data 330 included in the example event model training data of FIG. 3 are social media platform event count 330a, holiday count 330b (e.g., as obtained from an online encyclopedia or the like), sports webpage game count 330c, satellite emergency detection count 330d, government travel warning count 330e, and news platform emergency count 330f.

The training data additionally includes one or more event intensity scores 340 that may act as validation data for the events (e.g., to confirm that there was an event based on the changed activity represented in the event activity score), or may be a predicted result of a trained model (e.g., to train a model to predict a specific event activity score value given certain event data. The event intensity score 340 values may be representative of event intensity within a geofence for a specific time 310. Some examples of event intensity scores 340 included in the example model of FIG. 3 are trip drop-off count 340a, trip pickup count 340b, satellite night light level score 340c, satellite car count 340d, spatial anomaly category 340e, and call detail record activity count 340f. In some embodiments, an overall event intensity score 340g representative of a combination of one or more of the other event intensity score values is also included as labeled validation data for training the model.

In one example embodiment, the real-time data that the event prediction module 215 accesses or receives as input includes one or more of the data fields of the training data. Thus, for the training data, the real-time data that was available in the time leading up to a known event is used to train the model to predict that known event.

FIG. 4 is a high-level block diagram that illustrates a process of training an event model, in accordance with an embodiment. Event features to be included in the model are extracted by the feature extraction module 215 from data stored in the event data store 220 and the trip store 255. In some cases, features extracted from the trip store 255 include verification data about event intensity score values.

The feature extraction module 215 determines values corresponding to the one or more features that are available within a timeframe. Some example features 440, as shown in FIG. 4, include a number of celebrations 440a, a number of sports events, 440b, a number of trip pickups 440c facilitated by the system 130, a weather condition indicator 440d (e.g., a value representative of weather severity), a number of satellite detected cars 440e within the geofence, and a national holiday indicator 440f. Feature values extracted by the feature extraction module 215 may be based on structured data and/or unstructured data.

The event model generator 220 uses the features extracted by the feature extraction module 215 to train an event model 450. The event model 450 is a supervised machine learning model for predicting an outcome or classification, such as a decision tree, support vector machine, or neural network. The event model generator 220 may create a new event model 450 using the training features. In some cases, the event model generator 220 retrains an existing event model 450 when additional training data is received, for example, by incorporating new feature values into the training set. The features extracted by the feature extraction module 215 may correspond to one or more existing event models 450 in that they are representative of the same geofenced region, and in that they are representative of a temporal unit that is within the specified timeframe of the models 450. For example, feature values that are extracted for a specific hour may be used to train hour-level models with overall timeframes that include the specific hour the features represent. In some embodiments, the event model generator 220 accounts for the observed reliability of various features 440 when training an event model 450. For example, the event model generator 220 may initially train models to rely on features 400 extracted from structured data more than on features 400 extracted from unstructured data when predicting values for event intensity scores. In some embodiments, the event model generator 220 may adjust which features the event model 450 is trained to depend most heavily on by comparing the predicted values for event intensity scores, presented by an event model 450 with validated data about event intensity scores after the time period for which the predictions were made, has passed.

After the event model generator 220 generates a new version of an event model, the new event model is stored in the event model store 225. The event model 450 is used by the event prediction module 230 to determine event intensity scores representing event intensity with specified geofences and within specified timeframes.

FIG. 5 is an example map depicting geofences that correspond to predicted events, in accordance with an embodiment. In some examples, a geofence is pre-determined for portions of a region or map, in which events are located. In other examples, a geofence is generated for a candidate event to identify behavior and activity that may be associated with the event. In the example of FIG. 5, geofences 510 generated by the system 130 are shown as circles encompassing a predicted event area. The system 130 can monitor real-time information such as a number of pickups and/or dropoffs that occur within a generated geofence 510. Such monitoring may have a variety of functions. In one embodiment, data collected by monitoring a geofence generated around an area of a predicted event may be used to validate the event prediction (e.g., as a validation of event type and/or event intensity). For example, in FIG. 5, white circles represent geofences 510 that have been validated and black circles represent geofences for invalidated events 530 (e.g., some information was gathered for the area, but models have since determined that there is no event) and/or events that are yet to be validated. In one embodiment, monitored activities within the area may trigger certain proactive and/or reactive interventions, such as the interventions described above in relation to the intervention module 235.

Different embodiments may incorporate various intervention strategies. Interventions may include expanding 520 or contracting a geofence, for example, such that drop off areas can change as a function of detected or predicted drop-off rates within the geofence and/or as a function of the event intensity, as determined by event intensity score values (e.g., drop off and/or pickup areas might be a further distance from a venue depending on the number of people in an area). Another example of an intervention might be proactively recommending a future pickup time to a rider, when the rider is dropped off in a predicted event area, in order to reduce congestion when pickups occur at the time the event finishes. In such cases, the system 130 may additionally provide post-event recommendations, such as promotional discounts (e.g., discounts for a nearby restaurant or for the pickup ride) to track how many event participants delay their pickup after attending an event based on recommendations from the system 130.

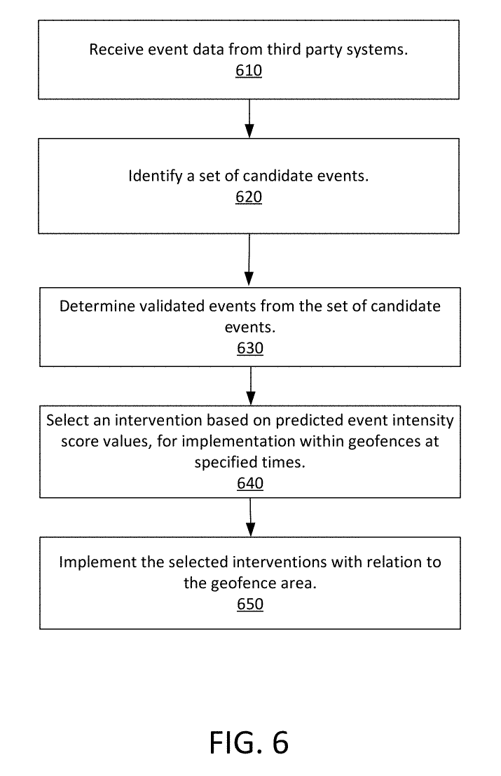

FIG. 6 is a flowchart illustrating a method of predicting events and event intensities within a geofence, in accordance with an embodiment. A system 130 receives 610 event data from one or more third party systems. Event data may be in the form of unstructured data (e.g., comments obtained from a webpage in natural language format) and/or structured event data (e.g., values obtained via calls to an API of a third party system). The system 130 identifies 620 a set of candidate events based on received event data. Candidate events may be identified using machine learned models or based on a threshold number of times an event is mentioned in the received event data.

In one embodiment, the system 130 trains one or more computer models to predict a type and/or intensity of events that may occur within a geofence. The system 130 determines 630 validated events from the set of candidate events, using the one or more computer models or classifiers. For example, validating an event may include determining which events from the set of candidate events have at least a threshold value of likelihood of being a certain type of event (e.g., weather event, emergency, celebration). In some embodiments, a corresponding event intensity may be determined. The intensity of an event may be represented by event intensity score values (e.g., predictions of a number of riders who will submit trip requests from within a geofence). The computer model for predicting event intensity is trained using data about past trips coordinated by the system 130 and using event data received from third party systems.

The system 130 selects 640 one or more interventions as appropriate responses to a predicted event type and corresponding predicted event intensity score values. Interventions can be in response to predicted future events, and/or in response to ongoing or past events detected by the system 130. Interventions may include generating a geofence around a predicted event area for monitoring purposes, optimizing pickup and drop-off locations with respect to event type and event intensity, routing providers around dangerous or congested areas, and/or sending messages to riders and providers about events and travel conditions. The system 130 implements 650 the selected interventions within or in relation to the geofenced areas for which the predictions were made.

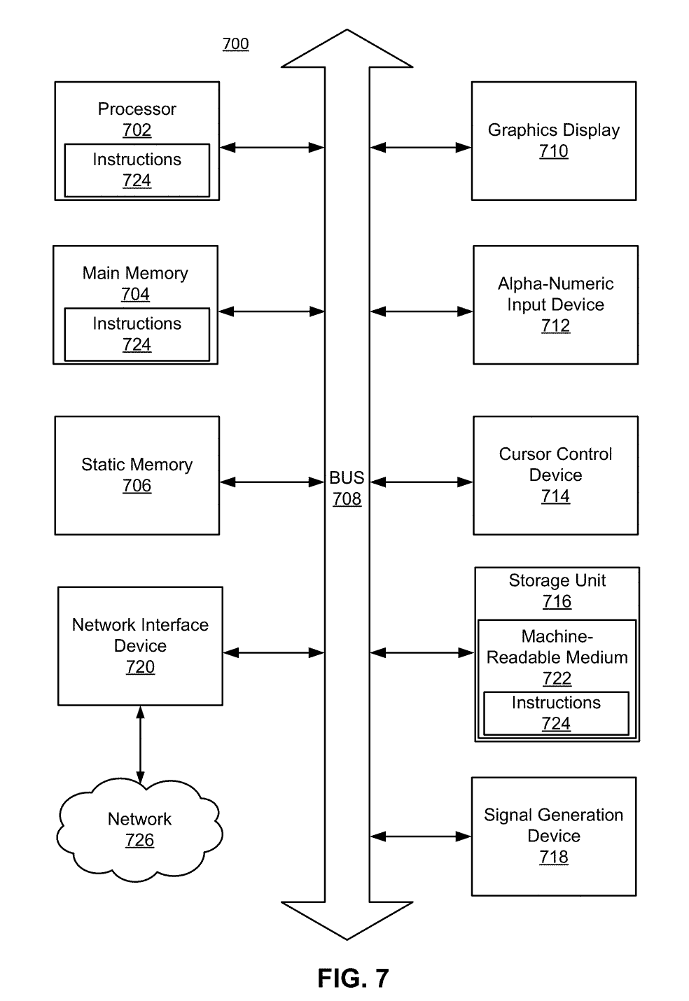

FIG. 7 is a block diagram illustrating components of an example machine for reading and executing instructions from a machine-readable medium. Specifically, FIG. 7 shows a diagrammatic representation of system 130 in the example form of a computer system 700. The computer system 700 can be used to execute instructions 724 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a smartphone, an internet of things (IoT) appliance, a network router, switch or bridge, or any machine capable of executing instructions 724 (sequential or otherwise) that specify actions to be taken by that machine. Further, while only a single machine is illustrated, the term “machine” shall also be taken to include any collection of machines that individually or jointly execute instructions 724 to perform any one or more of the methodologies discussed herein.

The example computer system 700 includes one or more processing units (generally processor 702). The processor 702 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The computer system 700 also includes a main memory 704. The computer system may include a storage unit 716. The processor 702, memory 704, and the storage unit 716 communicate via a bus 708.

In addition, the computer system 706 can include a static memory 706, a graphics display 710 (e.g., to drive a plasma display panel (PDP), a liquid crystal display (LCD), or a projector). The computer system 700 may also include alphanumeric input device 712 (e.g., a keyboard), a cursor control device 714 (e.g., a mouse, a trackball, a joystick, a motion sensor, or other pointing instrument), a signal generation device 718 (e.g., a speaker), and a network interface device 720, which also are configured to communicate via the bus 708.

The storage unit 716 includes a machine-readable medium 722 on which is stored instructions 724 (e.g., software) embodying any one or more of the methodologies or functions described herein. For example, the instructions 724 may include the functionalities of modules of the system 130 described in FIG. 2. The instructions 724 may also reside, completely or at least partially, within the main memory 704 or within the processor 702 (e.g., within a processor's cache memory) during execution thereof by the computer system 700, the main memory 704 and the processor 702 also constituting machine-readable media. The instructions 724 may be transmitted or received over a network 726 via the network interface device 720.

While machine-readable medium 722 is shown in an example embodiment to be a single medium, the term “machine-readable medium” should be taken to include a single medium or multiple media (e.g., a centralized or distributed database, or associated caches and servers) able to store the instructions 724. The term “machine-readable medium” shall also be taken to include any medium that is capable of storing instructions 724 for execution by the machine and that cause the machine to perform any one or more of the methodologies disclosed herein. The term “machine-readable medium” includes, but not be limited to, data repositories in the form of solid-state memories, optical media, and magnetic media.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure. For example, while the present disclosure discusses predicting provider involvement in potential safety incidents, the methods and systems herein can be used more generally for any purpose where one would want to predict involvement in potential incidents using a machine learning model.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A computer-implemented method comprising:
receiving trip data generated by providers and riders interacting with a system;
receiving event data describing possible events from third party systems that are external to the system;
generating a set of event intensity score values within a geofence within a certain timeframe by applying contemporary event data to an event prediction model;
selecting an intervention for implementation within the geofence responsive to the set of event intensity score values; and
implementing the selected intervention.

2. The computer-implemented method of claim 1, wherein event data includes information about a date and time of an event, a location of the event, a type of the event, or an expected number of attendees.

3. The computer-implemented method of claim 1, wherein trip data includes information about a pickup location and a drop off location, telematics data collected from the vehicle of the provider, safety incident reports about accidents or interpersonal conflicts that occurred during the trip, or feedback such as ratings and incident reports submitted by riders and providers.

4. The computer-implemented method of claim 1, wherein event intensity score values include one or more of a number of pickups in the geofence, a number of drop-offs in the geofence, a number of calls made from within the geofence, a score of light levels within the geofence as detected by satellite, and a number of cars within the geofence.

5. The computer-implemented method of claim 1, wherein interventions include proactive interventions.

6. The computer-implemented method of claim 1, wherein interventions include reactive interventions.

7. The computer-implemented method of claim 1, further comprising: training an event prediction model using the trip data and the event data, wherein the event prediction model predicts one or more event intensity score values as a function of trip data.

8. A non-transitory computer-readable storage medium storing computer program instructions executable by one or more processors of a system to perform steps comprising:
receiving trip data generated by providers and riders interacting with a system;
receiving event data describing possible events from third party systems that are external to the system;
generating a set of event intensity score values within a geofence within a certain timeframe by applying contemporary event data to an event prediction model;
selecting an intervention for implementation within the geofence responsive to the set of event intensity score values; and
implementing the selected intervention.

9. The non-transitory computer-readable storage medium of claim 8, wherein event data includes information about a date and time of an event, a location of the event, a type of the event, or an expected number of attendees.

10. The non-transitory computer-readable storage medium of claim 8, wherein trip data includes information about a pickup location and a drop off location, telematics data collected from the vehicle of the provider, safety incident reports about accidents or interpersonal conflicts that occurred during the trip, or feedback such as ratings and incident reports submitted by riders and providers.

11. The non-transitory computer-readable storage medium of claim 8, wherein event intensity score values include one or more of a number of pickups in the geofence, a number of drop-offs in the geofence, a number of calls made from within the geofence, a score of light levels within the geofence as detected by satellite, and a number of cars within the geofence.

12. The non-transitory computer-readable storage medium of claim 8, wherein interventions include proactive interventions.

13. The non-transitory computer-readable storage medium of claim 8, wherein interventions include reactive interventions.

14. The non-transitory computer-readable storage medium of claim 8, further comprising:
training an event prediction model using the trip data and the event data, wherein the event prediction model predicts one or more event intensity score values as a function of trip data.

15. A computer system comprising:
one or more computer processors for executing computer program instructions; and
a non-transitory computer-readable storage medium storing instructions executable by the one or more computer processors to perform steps comprising:
receiving trip data generated by providers and riders interacting with a system;
receiving event data describing possible events from third party systems that are external to the system;
generating a set of event intensity score values within a geofence within a certain timeframe by applying contemporary event data to an event prediction model;
selecting an intervention for implementation within the geofence responsive to the set of event intensity score values; and
implementing the selected intervention.

16. The computer system of claim 15, wherein event data includes information about a date and time of an event, a location of the event, a type of the event, or an expected number of attendees.

17. The computer system of claim 15, wherein trip data includes information about a pickup location and a drop off location, telematics data collected from the vehicle of the provider, safety incident reports about accidents or interpersonal conflicts that occurred during the trip, or feedback such as ratings and incident reports submitted by riders and providers.

18. The computer system of claim 15, wherein event intensity score values include one or more of a number of pickups in the geofence, a number of drop-offs in the geofence, a number of calls made from within the geofence, a score of light levels within the geofence as detected by satellite, and a number of cars within the geofence.

19. The computer system of claim 15, wherein interventions include proactive interventions.

20. The computer system of claim 15, further comprising: training an event prediction model using the trip data and the event data, wherein the event prediction model predicts one or more event intensity score values as a function of trip data.
